(19) United States
(12) Patent Application Publication
(10) Pub. No.: US 2010/0188739 A1
(43) Pub. Date: Jul. 29, 2010

(54) Tomographic Light Field Microscope

(75) Inventor: Mathew D. Watson, Bellevue, WA (US)

Correspondence Address: GEORGE A LEONE, SR;CITADEL PATENT LAW, 9124 Gravelly Lake Drive SW, SUITE 102, Lakewood, WA, 98499, US

(73) Assignee: VISIONGATE, INC., Gig Harbor, WA (US)

(21) Appl. No.: 12/689,396

(22) Filed: Jan. 19, 2010

Related U.S. Application Data
(60) Provisional application No. 61/145,717, filed on Jan. 19, 2009.

(51) Int. Cl. G02B 21/18

(52) U.S. Cl. 359/373

(57) ABSTRACT

An optical tomography system includes a light field microscope including an objective lens, a computer-controlled light source, a condenser lens assembly and a microlens array aligned along an optical axis. A carrier containing a specimen is coupled to a rotational driver for presenting varying angles of view of the specimen. A photosensor array disposed to receive photons from the objective lens. A computer is linked to control the computer-controlled light source and condenser lens assembly and the rotational driver, and coupled to receive images from the photosensor array where the light field microscope simultaneously captures a continuum of focal planes in the specimen for each of a set of the varying angles of view of the specimen.

### RELATED APPLICATIONS

This application hereby claims the benefit of prior filed co-pending U.S. provisional patent application No. 61/145,717, filed Jan. 19, 2009, of Mathew D. Watson, entitled “Tomographic Light Field Microscope,” which is incorporated herein by this reference.

### FIELD OF THE INVENTION

The present invention relates generally to analysis of medical imaging data, and, more particularly to employing a tomographic light field microscope in a biological cell imager.

### BACKGROUND OF THE INVENTION

In the field of optical tomography continuous scanning from multiple perspectives is used to acquire projection images from, effectively, an infinite number of adjacent focal planes. The focal plane of an optical imaging system is mechanically translated along an axis perpendicular to the focal plane through the thickness of a specimen during a single detector exposure. This is often referred to as “scanning” the focal plane. The process is repeated from multiple perspectives, either in series using a single illumination/detection subsystem, or in parallel using several illumination/detection subsystems. In this way, a set of pseudoprojections is generated, which can be input to a 3D tomographic image reconstruction algorithm. The method disclosed may be useful in applications such as high resolution optical tomography of small objects. One such system has been published as United States Patent Application Publication 2004-0076319, on Apr. 22, 2004, corresponding to pending U.S. patent application Ser. No. 10/716,744, filed Nov. 18, 2003, to Fauver, et al. and entitled “Method and Apparatus of Shadowgram Formation for Optical Tomography.” U.S. patent application Ser. No. 10/716,744 is incorporated herein by reference.

Fauver uses a piezoelectric transducer (PZT) to move an objective lens an axial distance of about 40 microns or more. In one useful embodiment, a micro-objective positioning system provides a suitable PZT, which is driven up and down along the optical “z” axis to scan the focal plane of the objective lens. Such a mechanical arrangement has limited scanning speed due to limiting factors such as the mass of the objective and speed of the piezoelectric element.

An example of a light field microscope is described in a patent application of Levoy et. al., published as US Publication No. US 2008-0266655 A1 on Oct. 30, 2008, corresponding to pending U.S. patent application Ser. No. 12/089,371, filed Apr. 4, 2008, and entitled “Microscopy Arrangements and Approaches.” FIG. 1 shows a light field microscope 10 including a condenser lens at “A,” a specimen at “B,” an objective at “C,” a microlens array at “F” and a photosensor array at “G.” Levoy et. al. is discloses a light field microscope that synthesizes a stack of focal images from a single camera exposure. Summing the focal stack images is substantially the same as scanning an objective lens to obtain a pseudo projection image. The synthesis employs a deconvolution step and wherein a processor computes a three-dimensional volume dataset of the specimen using tomography. The microlens array F allows z-axis information to be extracted while reducing the lateral resolution of the images as compared to the camera's resolution. However, Levoy et. al. does not disclose techniques for imaging objects from a plurality of viewpoints. U.S. patent application Ser. No. 12/089,371 is incorporated herein by reference.

Thus, a solution to the limitations of the prior art in acquiring pseudoprojections is desirable to increase throughput in an optical tomography system. Until the present invention no optical tomography system has been employed to acquire pseudoprojections from a rotating specimen carrier.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 is a schematic view of a light field microscope of the prior art; and

FIG. 2 schematically shows one example of an optical tomography system including a light field microscope with a rotating specimen carrier.

### DESCRIPTION OF THE PREFERRED EMBODIMENT

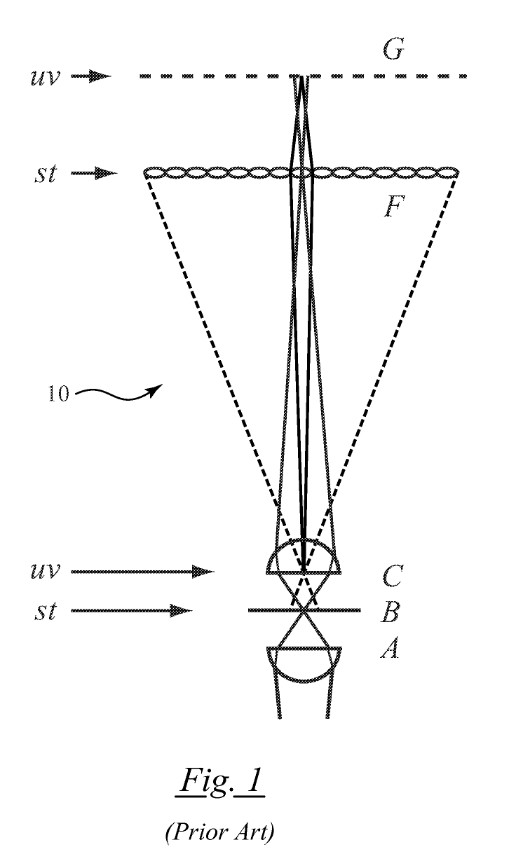

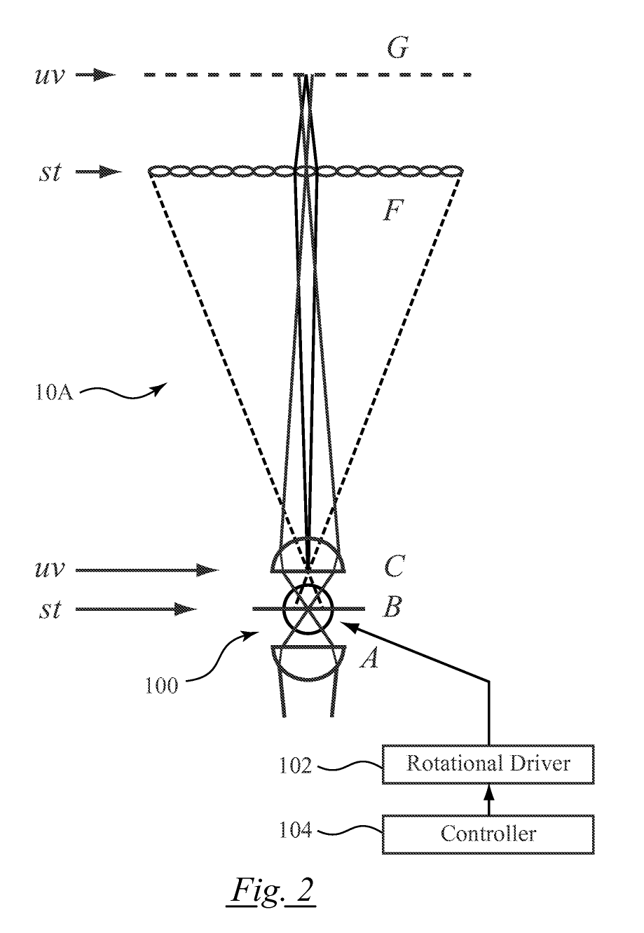

Referring now to FIG. 2, there shown is one example of an optical tomography system including a light field microscope with a rotating specimen carrier. The optical tomography system includes a light field microscope 10A constructed substantially as described above with respect to FIG. 1. A carrier 100 is adapted to hold a specimen and rotate with respect to the optical z axis so as to present a plurality of is varying viewpoints for imaging by the photosensor array G. In one useful embodiment the specimen carrier may comprise a capillary tube sized to hold a biological cell in a liquid or gel environment, where the liquid or gel is selected for optical properties matching the capillary tube to the lenses in the optical tomography system.

As compared to the optical tomography system of Fauver et al., the optical tomography system presented herein does not require scanning the objective lens for acquiring pseudoprojections. This reduces system complexity. As compared to a light field microscope, the optical tomography system presented herein adds a cell carrier to allow capture images from all directions around the cell. It is believed that multiple images improve the resolution of the 3D reconstruction.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An optical tomography system comprising:
a light field microscope including an objective lens, a computer-controlled light source, a condenser lens assembly and a microlens array aligned along an optical axis;
a carrier containing a specimen;
a rotational driver coupled to rotate the carrier to present varying angles of view of the specimen;
a photosensor array disposed to receive photons from the objective lens; and
a computer linked to control the computer-controlled light source and condenser lens assembly and the rotational driver, and coupled to receive images from the photosensor array where the light field microscope simultaneously captures a continuum of focal planes in the specimen for each of a set of the varying angles of is view of the specimen.

2. The system of claim 1 wherein the specimen is held in the micro-capillary tube with an index matching material that provides a uniform medium so as to reduce optical aberrations.

3. The system of claim 2 wherein the index matching material comprises material selected from the group consisting of optical gels, oils, fluids, polymer and epoxy.

4. The system of claim 1 wherein the specimen comprises a biological specimen.

5. The system of claim 1 wherein the specimen comprises a biological specimen stained with at least one stain selected from the group consisting of an absorptive dye, an absorbing and light scattering dye, an antibody labels, antibodies conjugated with metal particles, a quantum dot, a plastic micro-sphere, a fluorescent label and a molecular marker.

6. The system of claim 1 wherein the carrier comprises a microcapillary tube.

7. The system of claim 1 wherein the carrier comprises a cell carrier.
